(19) United States
(12) Patent Application Publication
(10) Pub. No.: US 2003/0031339 A1
(43) Pub. Date: Feb. 13, 2003

(54) Packaging and rf shielding for telecoils

(76) Inventors: Bowen F. Marshall, Rockport, ME (US); Alwin Fransen, Graswinckelstraat (NL)

Correspondence Address: Daniel J Burnham, Jenkens & Gilchrist, Suite 2600, 225 West Washington Street, Chicago, IL, 60606-3418, US

(21) Appl. No.: 10/169,817

(22) PCT Filed: Jan. 10, 2001
(86) PCT No.: PCT/US01/00795

(51) Int. Cl. H04R 1/00; H04R 9/06; H04R 11/02

(52) U.S. Cl. 381/400; 381/406

(57) ABSTRACT

Disclosed is a convenient way of mounting the microphone array and associated electronics of a hearing aid on the person, and providing a convenient wireless means for delivering the microphone signals to the ear, and providing a signal processing technique that yields sharp directivity at audio frequencies. The wearer positions her/his body to receive the desired signal and to attenuate surrounding background noise and multipath interference.

### FIELD OF THE INVENTION

The present invention relates generally to telecoils and, more particularly, to packaging and RF shielding for telecoils particularly suitable for hearing aids.

### BACKGROUND OF THE INVENTION

A conventional hearing aid may include both a microphone and a telecoil. In the hearing aid, the microphone only picks up acoustic sound waves, and the telecoil only picks up electromagnetic signals. The telecoil used in a hearing aid is a small electromagnetic induction coil, such as a wire wound around a magnetic bobbin. The telecoil produces a current when placed within an electromagnetic field. An alternating current of an audio signal moving through a wire creates the electromagnetic field. Placing the telecoil near the wire carrying the current of the audio signal induces a current in the telecoil through induction. The current in the telecoil is then amplified and sent to the speaker of the hearing aid.

A common use of the telecoil is with a telephone. The telephone headset includes speakers with induction coils. If an individual places the hearing aid with the telecoil adjacent the telephone headset, an alternating current in the induction coils of the telephone speakers creates an electromagnetic field that induces a current in the telecoil. The current of the telecoil is amplified and sent to the speaker of the hearing aid. Thus, the individual receives the telephone conversation without any background audio noises. Another use of the telecoil is to assist a listener with hearing sounds broadcast into a large room. Typically, a microphone sends the sound to loudspeakers, but the audio signal may also pass through a loop around the room. The audio signal passes through the loop, creating a magnetic induction field from which the telecoil picks up the speech without the common background audio noises.

One problem with the conventional telecoil is its susceptibility to electromagnetic interference. The telecoil not only picks up signals from audio band magnetic fields, but also from anything that produces electromagnetic fields, such as microwave ovens, lights, computer monitors, appliances, power lines, and elevator cables. Additionally, common digital cellular telephones provide a special concern. Digital cellular telephones act as a radio transmitter that may be picked up as noise by the telecoil, interfering with the desired audio signal.

Another shortcoming of conventional telecoils is that they are not readily available for surface mount applications. Typically, telecoils are a wrapping of wire about a coil. To protect the wire from environmental damage, the telecoil is normally dip-coated with a protective material. One problem with dip-coating the telecoil is the difficulty of maintaining the ends of the wire free from contamination by the coating. The ends of the wire need to form an electrical contact with other circuitry, and a dip-coated wire does not provide the necessary electrical contact for surface mounting the telecoil. Telecoils have also been protected from environmental damage with a shrink tube wrap that conforms to the wire around the coil while leaving the wire ends uncovered. For manufacturing hearing aids, these dip-coated and shrink-wrapped telecoils are manually placed and their wire ends are soldered to the appropriate circuitry. The manual placement and soldering of the telecoils is highly inefficient. Ideally, telecoils should be available for use on conventional automated equipment, such as conventional pick-and-place equipment, to surface mount the telecoils and reflow solder applications.

It is a general object of the present invention to solve the above problems. More particularly, a telecoil is desired that may be readily surface mounted, that is protected from environmental damage, and that provides shielding from electromagnetic interference.

### SUMMARY OF THE INVENTION

According to one aspect of the present invention, a packaged telecoil assembly is provided that comprises a telecoil, a substrate, and a cover. The telecoil is connected to the substrate, and the cover joins with the substrate to enclose the telecoil. The assembly may further include an integrated circuit that connects to the substrate and is capable of receiving a signal from the telecoil. The telecoil may be end mounted or side mounted to the integrated circuit. To shield the telecoil from RF energy, the cover comprises an electrically conductive and at least partially nonmagnetic material. As used herein, the term “RF” refers generally to signals in the range of 30 kHz up to 300 GHz. Additionally, the cover may be electrically connected to an electrically conductive ground plane on or within the substrate. The cover may comprise a metal, a plastic, and/or an ecapsulent material. Surface mount contacts on an exterior surface of the substrate provide electrical connections to the telecoil enclosed by the cover.

### BRIEF DESCRIPTION OF THE DRAWINGS

The foregoing and other advantages of the invention will become apparent upon reading the following detailed description and upon reference to the drawings.

FIG. 1a is a front view of an unpackaged telecoil assembly.

FIG. 1b is a side view of the unpackaged telecoil assembly of FIG. 1a.

FIG. 2a is an isometric view of a cover packaged telecoil assembly according to one embodiment of the present invention.

FIG. 2b is a top view of the cover packaged telecoil assembly of FIG. 2a.

FIG. 3a is a cross-section of the cover packaged telecoil assembly of FIG. 2a along line 3A-3A according to one embodiment of the present invention.

FIG. 3b is a cross-section of the cover packaged telecoil assembly of FIG. 2a along line 3B-3B according to one embodiment of the present invention.

FIG. 4a is a cross-section of the cover packaged telecoil assembly of FIG. 2a along line 3A-3A according to another embodiment of the present invention.

FIG. 4b is a cross-section of the cover packaged telecoil assembly of FIG. 2a along line 3B-3B according to another embodiment of the present invention.

FIG. 5a is a front view of a cover packaged telecoil assembly according to another embodiment of the present invention.

FIG. 5b is a side view of the cover packaged telecoil assembly of FIG. 5a.

FIG. 6a is a front view of a cover packaged telecoil assembly having surface mount contacts according to one embodiment of the present invention.

FIG. 6b is a side view of the cover packaged telecoil assembly of FIG. 6a.

FIG. 6c is a bottom view of the cover packaged telecoil assembly of FIG. 6a.

FIG. 7a is a front view of a cover packaged telecoil assembly having terminals according to another embodiment of the present invention.

FIG. 7b is a side view of the cover packaged telecoil assembly of FIG. 7a.

FIG. 7c is a bottom view of the cover packaged telecoil assembly of FIG. 7a.

FIG. 8a is a bottom view of a cover packaged telecoil assembly having surface mount contacts according to another embodiment of the present invention.

FIG. 8b is a bottom view of a cover packaged telecoil assembly having surface mount contacts according to another embodiment of the present invention.

FIG. 8c is a bottom view of a cover packaged telecoil assembly having surface mount contacts according to another embodiment of the present invention.

FIG. 9a is a front view of a cover packaged telecoil assembly having surface mount contacts according to another embodiment of the present invention.

FIG. 9b is a side view of the cover packaged telecoil assembly of FIG. 9a.

FIG. 9c is a front view of a cover packaged telecoil assembly having surface mount contacts according to another embodiment of the present invention.

FIG. 9d is a side view of the cover packaged telecoil assembly of FIG. 9c.

FIG. 10a is a front view of a cover packaged telecoil assembly having surface mount contacts according to another embodiment of the present invention.

FIG. 10b is a side view of the cover packaged telecoil assembly of FIG. 10a.

FIG. 10c is a front view of a cover packaged telecoil assembly having surface mount contacts according to another embodiment of the present invention.

FIG. 10d is a side view of the cover packaged telecoil assembly of FIG. 10c.

FIG. 10e is a front view of a surface mount contact according to another embodiment of the present invention.

FIG. 11 is a front view of an unpackaged end mounted telecoil assembly.

FIG. 12a is a front view of a cover packaged telecoil assembly according to one embodiment of the present invention.

FIG. 12b is a side view of the cover packaged telecoil assembly of FIG. 12a.

FIG. 12c is a cross-section of the cover packaged telecoil assembly of FIG. 12b along line 12C-12C according to one embodiment of the present invention.

FIG. 12d is a cross-section of the cover packaged telecoil assembly of FIG. 12a along line 12D-12D according to one embodiment of the present invention.

FIG. 13a is a front view of a cover packaged telecoil assembly according to another embodiment of the present invention.

FIG. 13b is a side view of the cover packaged telecoil assembly of FIG. 13a.

FIG. 14 is an isometric view of a mold packaged telecoil assembly according to one embodiment of the present invention.

FIG. 15 is a side view of an apparatus for forming the mold packaged telecoil assembly of FIG. 14.

FIG. 16a is a cross-section of the mold packaged telecoil assembly of FIG. 14 along line 16A-16A according to one embodiment of the present invention.

FIG. 16b is a cross-section of the mold packaged telecoil assembly of FIG. 14 along line 16B-16B according to one embodiment of the present invention.

FIG. 17a is a cross-section of a mold packaged telecoil assembly according to another embodiment of the present invention.

FIG. 17b is a cross-section of the mold packaged telecoil assembly of FIG. 17a.

FIG. 17c is a cross-section of a mold packaged telecoil assembly according to another embodiment of the present invention.

FIG. 17d is a cross-section of the mold packaged telecoil assembly of FIG. 17c.

FIG. 18a is a cross-section of a mold packaged telecoil assembly according to another embodiment of the present invention.

FIG. 18b is a cross-section of the mold packaged telecoil assembly of FIG. 18a.

FIG. 19 is a side cross-section of a telecoil assembly that further includes internal shielding around the integrated circuit.

FIG. 20 is a bottom view of a telecoil assembly having enlarged contact pads that allow the telecoil assembly to be positionally adjusted on the component to which it is attached.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

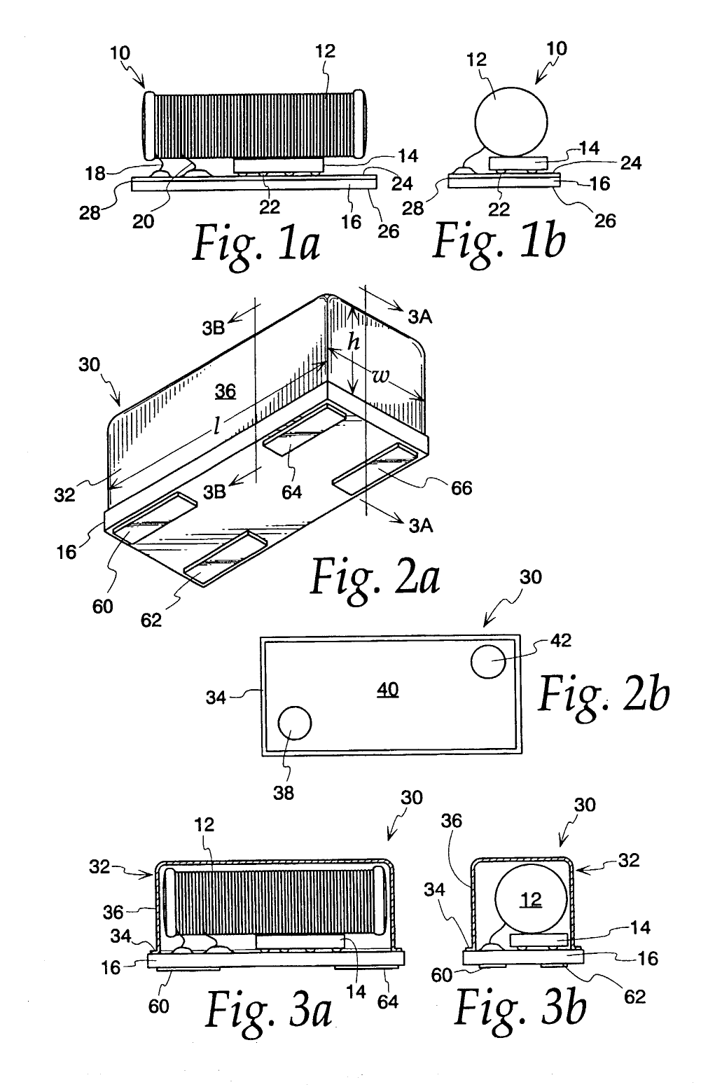

Turning now to the drawings and referring initially to FIGS. 1a and 1b, there is depicted a conventional unpackaged telecoil assembly 10 suitable for use in a hearing instrument. The telecoil assembly 10 comprises a telecoil 12, an integrated circuit 14, and a substrate 16. The telecoil 12 is a conventional telecoil comprising a winding of wire about a highly permeable core or bobbin. In one embodiment, the telecoil comprises a copper wire of 54 American Wire Gauge wrapped around a NiFe alloy bobbin. The wire has two wire ends 18 and 20 for providing the current signal. Preferably, the wire of the telecoil 12 has a temperature rating higher than 155° C. to withstand the reflow temperatures associated with conventional reflow soldering techniques. While the telecoil 12 and its core are shown as being cylindrical in shape, the present invention is useful for telecoils of any cross-sectional shape, such as a square, a rectangle, and an oval.

As depicted in FIG. 1a, the ends 18 and 20 of the telecoil 12 are soldered to the substrate 16. The substrate 16 provides electrical connections (not shown) from the ends 18 and 20 to terminals 22 of the integrated circuit 14. The ends 18 and 20 of the telecoil 12 provide the output signal of the telecoil 12 (i.e., a current representative of the audio signal received from the induction loop) to the terminals 22 of the integrated circuit 14. The integrated circuit 14 processes (e.g., amplifies) the telecoil signal that is then output through another one of the terminal 22. One example of the integrated circuit 14 is a GENNUM GC562. For the integrated circuit 14 to provide the amplification, the integrated circuit 14 also has inputs through terminals 22 of a common ground and a battery signal. In another embodiment, the integrated circuit further includes an A/D converter which provides a digital output of the frequency signal picked up by the telecoil 12. The digital output may have any common digital format, such as I²S output, pulse width, pulse density modulated, etc. The assembly 10 may also include components such as capacitors and resistors.

The substrate 16 has a top surface 24 and a bottom surface 26. The top surface 24 provides a mounting surface for the integrated circuit 14 and/or the telecoil 12. In the embodiment depicted in FIG. 1a, the telecoil 12 is joined to the top of the integrated circuit 14 with an appropriate quick-set cement, and the integrated circuit 14 is connected to the top surface 24 of the substrate 16 with the terminals 22. In one embodiment, the integrated circuit 14 is a flip-chip integrated circuit for connecting to the substrate 16. Because the telecoil 12 is mounted on its side relative to the substrate 16, the telecoil assembly 10 is typically called a side mounted telecoil assembly. The substrate 16 also provides electrical connections between the telecoil 12 and the integrated circuit 14 and electrical connections from the integrated circuit 14 to external components. The electrical connections between the telecoil 12, the integrated circuit 14, and the substrate 16 are made as one skilled in the art would know, such as soldering, welding, wire bonds, conductive adhesives, etched or screen printed traces. The substrate 16 is composed of a solid circuit board material, such as ceramic, glass epoxy, or flexible polyimide board. Additionally, these substrates may be multi-layered and include thick or thin film components, such as a thin electrically conductive ground plane 28. Although FIGS. 1a and 1b illustrate the ground plane 28 within the substrate 16, the ground plane may be on the top surface 24, the bottom surface 26, and/or within the substrate 16, as known to one skilled in the art. As is described below, the ground plane 28 assists in the electromagnetic shielding of the telecoil 12 and its mating components. Further, the ground plane 28 can serve another function in that it can be used with a dielectric material and another conductive plane to create a plate capacitor that filters the undesirable RF noise signals that may be superimposed over the desired telecoil signal. The presence of multiple conductive layers (outer layers or intermediate layers) in the substrate 16 allows for it to be used as an efficient distributed bypass capacitor. Accordingly, the ground plane 28 would be serving two distinct functions (i.e., shielding and filtering) that assist in developing and processing a cleaner signal.

The telecoil assembly 10 depicted in FIGS. 1a and 1b is known as an active telecoil assembly because it includes the amplifying integrated circuit 14. Another embodiment of the telecoil assembly, known as a passive telecoil assembly, excludes the integrated circuit. For the passive telecoil assembly, the telecoil 12 would be cemented directly to the substrate 16, and the ends 18 and 20 would be electrically connected through the substrate 16 to allow external components to receive the current signal generated by the telecoil 12.

The present invention is directed to packaged telecoil assemblies. FIG. 2a illustrates one embodiment of a cover packaged telecoil assembly 30A. The cover packaged telecoil assembly 30A comprises a cover 32A joined to the substrate 16 to form a unitary protective package. The cover 32A and the substrate 16 encase the telecoil 12 and the integrated circuit 14. The cover 32A in FIG. 2a may be considered a side mounted cover because the cover 32A has one open side to envelop the telecoil 12. The cover 32A is properly dimensioned and shaped to enclose the telecoil assembly 10 while minimizing the overall size of the protective package. To minimize the size of the packaged assembly 30A, the height “h” of the cover 32A is sufficient to accommodate the telecoil 12. In other embodiments, size may not be a consideration and the height of the cover 32A may vary greatly relative to the telecoil 12.

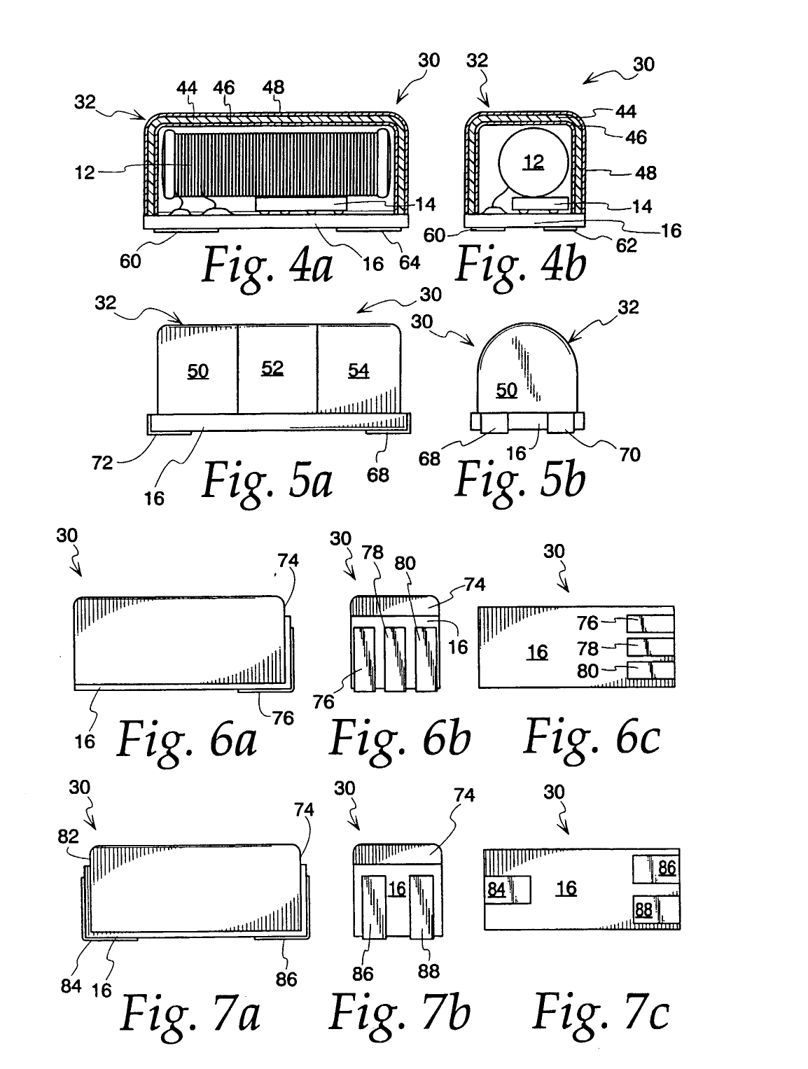

In the illustrated embodiment in FIG. 2a, the cover 32A has edges 34 that are turned flat, that is, the cover 32A has vertical walls 36 that turn into the horizontal edges 34. The horizontal edges 34 provide a bonding and sealing surface between the cover 32A and the top surface 24 of the substrate 16. In FIG. 2a, the length “l” and width “w” of the cover 32A at the vertical walls 36 is slightly less than the length and width of the substrate 16 to form the flat edges 34. The flat edges 34 (see FIG. 3a) abut the top surface 24 of the substrate 16 along the entire periphery of the cover 32A. In alternative embodiments, the vertical walls 36 terminate as ends to abut the top surface 24 of the substrate 16, as illustrated in FIGS. 4a and 4b. In the alternative embodiments, the periphery of the cover 32A may be slightly smaller, exactly match, or be slightly larger than the periphery of the substrate 16 as long as the cover 32A and the substrate form the unitary protective package for the telecoil assembly 10.

To form the unitary package, the cover 32A is bonded or joined to the substrate 16 using an appropriate adhesive or weld. To protect from environmental contamination, the bond between the cover 32A and the substrate 16 is sealed. Sealing fills any openings or gaps between the cover 32A and the substrate 16. The seal may be formed with an appropriate epoxy or polyurethane coating. In an alternative embodiment, the cover 32A, after being bonded to the substrate, may be filled with an encapsulating material such as epoxy or an appropriate casting material. The epoxy fills the space enclosed between the cover 32A and the substrate 16 through a fill hole 38 in the top side 40 of the cover 32A. To allow trapped air to escape when the epoxy fills the space between the cover and the substrate 16, the top wall 40 of the cover includes a vent hole 42. For the epoxy-filled embodiment, the cover 32A does not need to be sealed to the substrate 16 because the epoxy prevents any environmental contamination of the telecoil 12 and the integrated circuit 14.

The cross-sectional shape of the cover 32A may be any shape that accommodates the telecoil 12, including rectangular, semicircular, elliptical, parabolic, and trapezoidal. For example, the cross-sectional shape of the cover 32A in FIG. 3b is approximately rectangular, and the cross-sectional shape of the cover 32A in FIG. 5b is elliptical or barn-shaped. In one embodiment, the cross-sectional shape is selected to minimize the overall size of the cover packaged telecoil assembly 10. In another embodiment, the cross-sectional shape may be influenced by the automated pick-and-place manufacturing techniques.

The cover 32A is composed of a material to allow the cover packaged telecoil assembly 30A to be handled without being easily damaged. For example, the cover 32A should be able to withstand the forces applied by manual placement and/or the standard pick-and-place manufacturing techniques. FIGS. 3a and 3b illustrate the cross-section of one embodiment of the cover 32A. The cover 32A comprises a nonferrous drawn metal, such as stainless steel, brass, and copper. In one embodiment, the cover 32A comprises stainless steel having an appropriate thickness to provide the necessary structural strength while minimizing the size and weight of the assembly 30A.

Because the telecoil 12 is susceptible not only to physical damage, but also to electromagnetic interference, it is desired that the packaging provide RF electromagnetic shielding for the enclosed telecoil 12. Such a shield must be electrically conductive and, at least in part, nonmagnetic to allow the telecoil 12 to perform its function of detecting audio band magnetic fields. To be effective, the shield should enclose the telecoil 12 with minimum non-conductive openings and provide conductive paths around the periphery of the shield of all three orthogonal planes. By providing the continuous conductor about the periphery, the nonmagnetic energy in the field is conducted around the shield. Additionally, the continuous conductor path around the telecoil 12 in all three orthogonal planes includes the ground plane normally connected to a local electrical common.

The cover 32A and substrate 16 may readily provide the RF shielding for the packaged telecoil assembly 30A. In one embodiment, the RF shield comprises the cover 32A composed of the nonmagnetic metal and the substrate 16 having a metallic layer or ground plane 28 on or within the substrate 16. The edges 34 of the metal cover 32A connect to the ends and sides of the ground plane 28 of the substrate 16 to complete the RF shield. Thus, the packaging for the telecoil 12 functions as the RF shield. Additional EMI shielding may be provided to the cover packaged telecoil assembly 30A comprising the metal cover by adding a conformal insulating layer, such as parylene, over the cover packaged telecoil assembly 30A, and then gold coating the entire assembly. The gold coat and conformal insulating layer is discussed in detail in conjunction with FIGS. 16a and 16b.

FIGS. 4a and 4b illustrate another RF shielding embodiment for the cover packaged telecoil assembly 30B. The cover 32B comprises a metal coated plastic cover having a center plastic layer 44 and metal layers or coatings 46 and 48 on the inner and outer surface of the plastic layer 44. The plastic layer 44 provides sufficient structural strength to withstand manual placement and/or pick-and-place manufacturing techniques, and the metal coatings 46 and 48 provide RF shielding. In one embodiment, the metal coatings 46 and 48 are comprised of a high electrical conductivity coating such as gold, silver, copper, or aluminum. The thickness of the metal coatings 46 and 48 is selected to provide an effective RF shield. Similar to the edges 34 of the metal cover in FIGS. 3a and 3b, the metal coatings 46 and 48 at the edges of the cover 32B are connected to the sides and ends of the ground plane on or within the substrate 16. In one embodiment, the inner metal coating 46 is connected to the sides and ends of the ground plane on or within the substrate 16, and the outer metal coating 48 is not connected to the ground plane, but is left floating or connected to an external component. Additionally, the outer coating 48 may be connected to another electrically conductive layer deposited on the bottom of the substrate 16 to provide the second RF shield. Although FIGS. 4a and 4b illustrate the plastic cover 32B having both the inner metal coating 46 and the outer metal coating 48, only one of the metal coatings may be used to provide the RF shielding. Two metal coatings, however, provide greater shielding than a single metal coating.

FIGS. 5a and 5b illustrate another RF shielding embodiment for the cover packaged telecoil 30C. The cover 32C comprises three metal portions 50, 52 and 54, physically and electrically connected together to form the unitary cover 32C. The three metal portions 50, 52 and 54 are connected by appropriate means, such as welded or soldered together. To provide the RF shielding, the first metal portion 50 and the third metal portion 54 are highly magnetic metals, such as highly permeable NiFe metal alloy. The center metal portion 52 is a non-magnetic metal, such as stainless steel, brass, or copper. To complete the RF shield, the cover 32C is electrically connected to the edges and ends of the ground plane on or within the substrate 16. The three portion metal cover 32C depicted in FIG. 5a functions similarly to the single piece metal cover depicted in FIG. 3a by providing the continuous conductor path around the telecoil 12 in all three orthogonal planes.

In addition to RF shielding, the embodiment of FIG. 5a enhances the sensitivity of the telecoil 12. The high permeability NiFe metal portions 50 and 54 are placed around or adjacent to the ends of the telecoil bobbin. Joining and separating these portions 50 and 54 is the electrically conductive, but nonmagnetic, central portion 52. This arrangement increases the magnetic flux concentrating function of the telecoil bobbin by several decibels (dB). Thus, the effective sensitivity of the telecoil 12 to audio frequency magnetic fields is increased. In one embodiment, the portions 50, 52 and 54 are approximately the same size; however, the respective sizes of the portions 50, 52 and 54 may be optimized for different telecoil geometries to optimize the sensitivity of the telecoil.

In a further embodiment, the cover packaged telecoil assembly 30 may be temperature insulated. A layer of temperature insulating material, such as Kapton, may encase the entire assembly 30. Alternatively, the epoxy selected for encapsulating the telecoil 12 for the embodiment described above in conjunction with FIG. 2b may have temperature insulating properties. Additionally, the plastic layer 46 of the cover 32B of FIG. 4a may also have temperature insulating properties.

To provide the electrical connections between the electrical components of the packaged telecoil assembly 30A and other exterior components of the hearing aid, the packaged telecoil assembly 30A depicted in FIG. 2a includes surface mount contacts or terminations 60, 62, 64 and 66. Any number of surface mount contacts may be provided depending on the requirements of the specific telecoil assembly. For example, the active telecoil assembly would typically require at least three surface mount contacts, one for the battery signal connection to power the integrated circuit 14, one for the common ground connection, and one for the amplified telecoil output connection. The passive telecoil assembly only requires two surface mount contacts for the connections to the wire ends of the telecoil. The surface mount contacts 60, 62, 64 and 66 provide contact areas that may be electrically connected to other components of the hearing device. The surface mount contacts may be formed using screen printing and firing of metal alloy pastes on ceramic substrates, etched copper cladding on glass epoxy or polyimide substrates, etched copper cladding on flex print board substrates, metal tabs or lead frame welded or soldered to the appropriate substrate, or other materials and methods suitable for forming electrical contacts known to one skilled in the art. The following briefly describes some embodiments for forming the surface mount contacts on the packaged telecoil assembly.

FIG. 2a illustrates the cover packaged telecoil assembly 30A with surface mount contacts 60, 62, 64 and 66. In one embodiment, the substrate 16 comprises a ceramic material and the contacts 60, 62, 64 and 66 are screen printed terminals. Briefly, screen printing comprises placing a stencil having openings corresponding to the desired size and location for the surface mount contacts 60, 62, 64 and 66 over the bottom surface 26 of the substrate 16. A coating of a metal alloy paste is then applied over the stencil to fill the openings to form electrically conductive metal areas for the surface mount contacts 60, 62, 64 and 66 while leaving the remaining portions of the bottom surface 26 of the substrate 16 non-electrically conductive. The substrate 16, with metal paste for the surface mount contacts 60, 62, 64 and 66, is then fired at a predetermined temperature for a predetermined time to set the paste to a solid metal. Electrically conductive connection pads, vias, and/or traces (not shown) provide the electrical connections between the terminals 22 (FIGS. 1a and 1b) of the integrated circuit 14 through the substrate 16 to the screen printed surface mount contacts 60, 62, 64 and 66. The through connections on the substrate 16 may be formed by laser cutting holes through the substrate 16 that are then filled with electrically conductive alloy.

In an alternative embodiment for FIG. 2a, the substrate 16 comprises a copper clad polyimide or copper clad glass epoxy, and the surface mount contacts 60, 62, 64 and 66 are etched terminals on the bottom surface 26 of the substrate 16. Briefly, the surface mount contacts are etched out of the copper clad bottom surface 26 of the substrate 16. A stencil having a covering corresponding to the desired size and location for the surface mount contacts 60, 62, 64 and 66 is placed over the copper clad bottom surface 26 of the substrate 16. The uncovered copper layer on the bottom surface 26 is then etched away using optic etching or an abrasive paste. After the etching step, the surface mount contacts 60, 62, 64 and 66 comprising electrically conductive copper remain, while the rest of the bottom surface 26 of the substrate 16 is non-electrically conductive. Electrically conductive connection pads, vias, and/or traces (not shown) provide the electrical connections between the terminals 22 of the integrated circuit 14 through the substrate 16 to the etched surface mount contacts 60, 62, 64 and 66.

FIGS. 5a and 5b illustrate another surface mount contact arrangement for the packaged telecoil assembly 30C. The substrate 16 comprises a ceramic material, and the surface mounted contacts 68, 70 and 72 are screen printed terminals. Briefly, the screen printing for this embodiment would comprise a stencil that covers the bottom surface 26 (FIGS. 1a and 1b) and sides of the substrate 16 to place the metal alloy paste for the surface mount contacts 68, 70 and 72. The surface mount contacts 68, 70 and 72 provide contact areas for electrical connections, such as by soldering, on both the bottom of the substrate 16 and contact areas on the adjacent vertical surface (side) of the assembly 30C. Because a portion of the contacts 68, 70 and 72 lie adjacent the vertical or side surface of the assembly 30C, edge metallization provides the electrical connections between the terminals 22 of the integrated circuit 14 and the screen printed contacts 68, 70 and 72. Simply, electrically conductive traces pass from selected terminals 22 of the integrated circuit 14 to the edges of the top surface 24 of the substrate 16 to provide the electrical connections for the surface mount contacts 68, 70 and 72.

FIGS. 6a, 6b and 6c illustrate another surface mount contact arrangement for the packaged telecoil assembly 30D. The substrate 16D comprises a flex print board that wraps around one end 74 of assembly 30D. The end 74 of the assembly 30D is one of the narrow ends measuring the width “w” (see FIG. 2a) of the assembly 30D. The surface mount contacts 76, 78 and 80 also fold over the end 74 of the assembly 30D on the bottom surface of the flex print substrate 16D. The surface mount contacts 76, 78 and 80 are formed on the flex print substrate 16D in a similar manner as the etched terminals on the copper clad substrate described above. Briefly, the flex print board provides an electrically conductive metallized bottom surface of the substrate 16D. A stencil having a covering corresponding to the desired size and location for the surface mount contacts 76, 78 and 80 is placed over the bottom surface, including the folded over portion. The etching step provides the surface mount contacts 76, 78 and 80 with contact areas on both the bottom (see FIG. 6c) and the adjacent vertical surface (end) 74 of the assembly 30D (see FIG. 6b). Electrically conductive connection pads, vias, and/or traces (not shown) provide the electrical connections between the terminals 22 of the integrated circuit 14 through the substrate 16D to the surface mount contacts 76, 78 and 80.

FIGS. 7a, 7b and 7c illustrate another surface mount contact arrangement for the packaged telecoil assembly 30E. The substrate 16E comprises a flex print board that wraps around two ends 74 and 82 of assembly 30E. The surface mount contact 84 wraps around the end 82 of the assembly 30E over the bottom surface of the flex print substrate 16E, and the surface mount contacts 86 and 88 wrap around the end 74 of the assembly 30E over the bottom surface of the flex print substrate 16E. The surface mount contacts 84, 86 and 88 are formed on the flex print substrate in a manner similar to the contacts 76, 78 and 80 of FIG. 6a. Instead of three contacts 76, 78 and 80 etched to wrap around the end 74, two contacts 86 and 88 are etched to wrap on the end 74 and one contact 84 is etched to wrap around the end 82. Electrically conductive connection pads, vias, and/or traces (not shown) provide the electrical connections between the terminals 22 of the integrated circuit 14 through the substrate 16E to the etched surface mount contacts 84, 86 and 88. The embodiment depicted in FIGS. 7a, 7b and 7c provide contact areas for soldering on both the bottom of the substrate 16E (see FIG. 6c) and contact areas on two of the adjacent vertical surfaces (ends) 74 and 82 of the assembly 30E (see FIG. 6b).

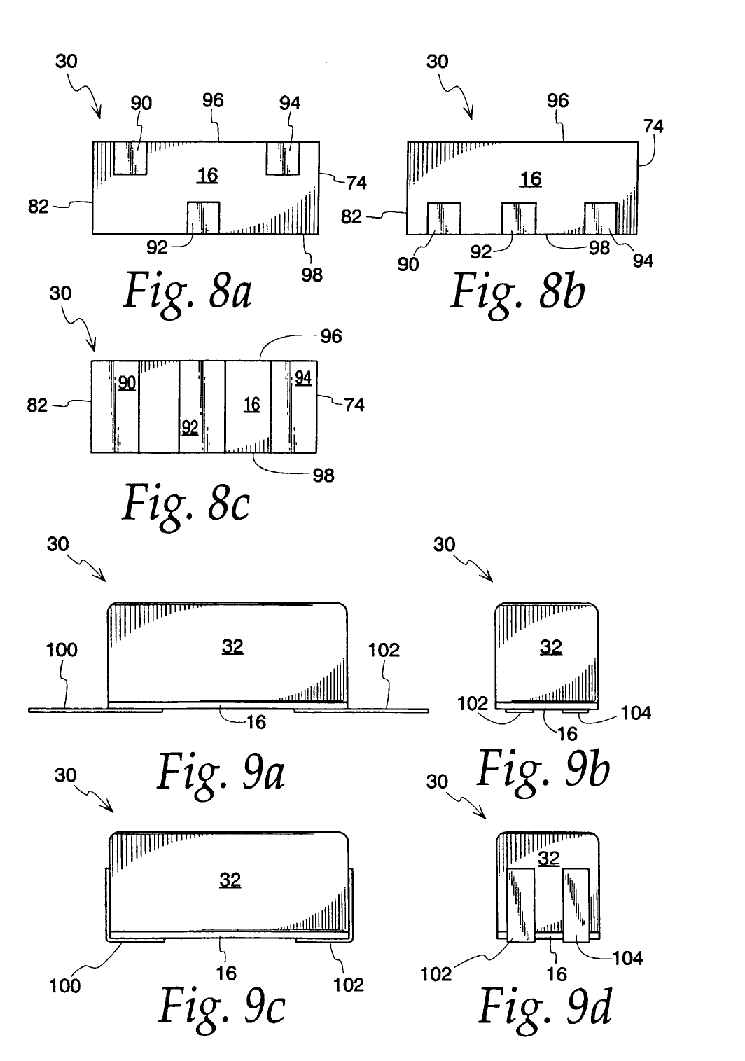

FIGS. 8a, 8b and 8c illustrate some alternative surface mount contact locations on the bottom of the substrate 16. The surface mount contacts 90, 92 and 94 may either be contained only on the bottom of the substrate 16, like the embodiment depicted in FIG. 2a, or wrapped around to an adjacent side like the embodiments in FIGS. 5a, 6a and 7a. For the embodiment of FIG. 8a, two of the contacts 90 and 94 are adjacent one of the long ends 96 of the assembly 30 represented by the length “l” (see FIG. 2a), and the remaining contact 92 is adjacent the opposite long end 98. For the embodiment of FIG. 8b, all three of the contacts 90, 92 and 94 are adjacent one of the long ends 98 of the assembly 30. For the embodiment depicted in FIG. 8c, the contacts extend completely across the bottom of the substrate 16 from one end 96 to the opposite end 98 of the assembly 30. The embodiments of surface mount contact placement illustrated in the above Figures do not represent all of the ways of orienting the contacts. Typically, the placement of the assembly relative to other circuit components will dictate the arrangement of the surface mount contacts. Rather, the Figures illustrate some of the many possible embodiments that would be known to one skilled in the art.

FIGS. 9a, 9b, 9c and 9d illustrate another surface mount contact arrangement for the packaged telecoil assembly 30F. The substrate 16F comprises a ceramic material, and three surface mounted contacts 100, 102 and 104 are bottom mounted metal tabs. The metal tabs are welded to the bottom surface of the substrate 16F to form the surface mount contacts 100, 102 and 104. The metal tabs may be part of a larger metal lead frame to allow several contacts to be welded to several substrates prior to being cut apart. Electrically conductive connection pads, vias, and/or traces (not shown) provide the electrical connections between the terminals 22 of the integrated circuit 14 (FIGS. 1a and 1b) through the substrate 16F to the metal tab contacts 100, 102 and 104. The contacts may remain flat as illustrated in FIG. 9a or the contacts may be folded to abut the adjacent vertical ends of the assembly 30F as illustrated in FIG. 9c.

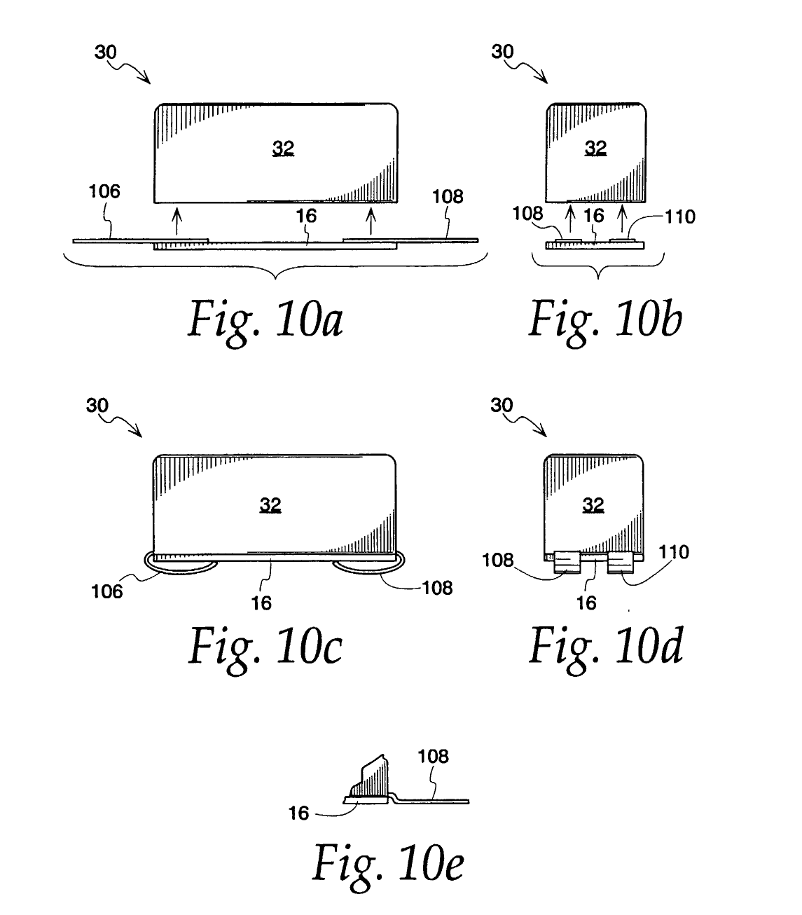

FIGS. 10a, 10b, 10c, 10d and 10e illustrate another surface mount contact arrangement for the packaged telecoil assembly 30G. The substrate 16G comprises a ceramic material, and three surface mounted contacts 106, 108 and 110 are top mounted metal tabs. The contacts 106, 108 and 110 are welded to the top of the substrate 16G before attaching the cover 32 to the substrate 16G. The contacts 106, 108 and 110 electrically connect to the terminals 22 of the integrated circuit 14 (FIGS. 1a and 1b). To provide the contact areas on the bottom of the substrate 16G, the contacts 106, 108 and 110 are folded to the bottom of the substrate 16G (see FIGS. 10c and 10d) into a J-bend style. In an alternative embodiment, the contacts 106, 108 and 110 may be bent downward into a gull-wing style as depicted in FIG. 10e.

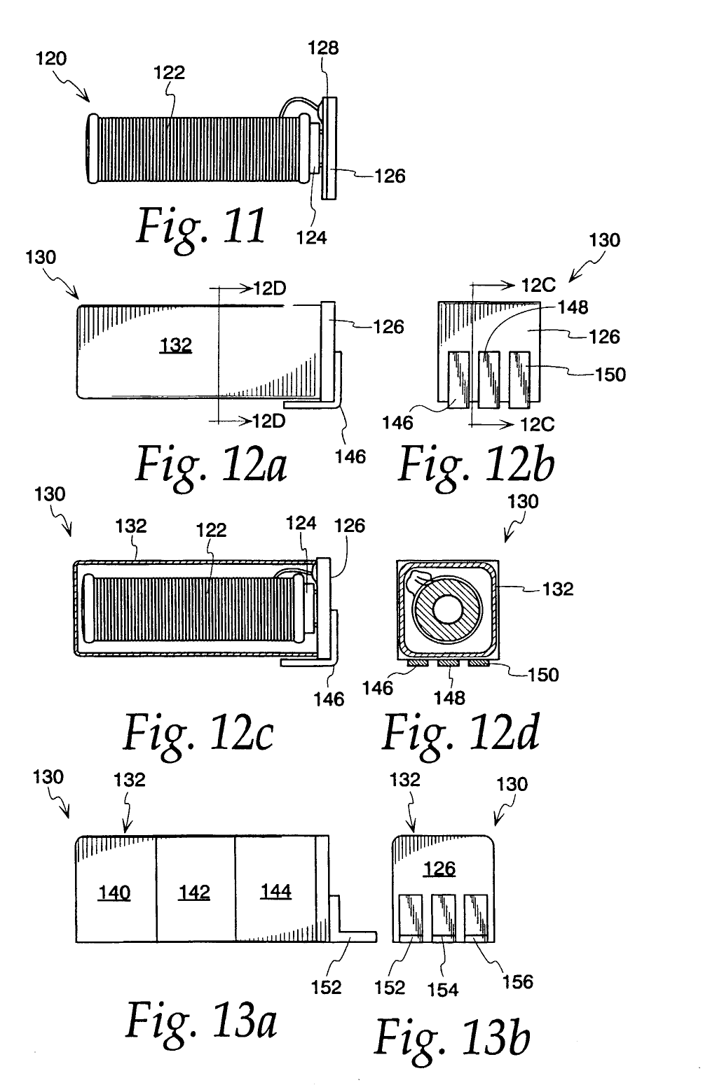

The above-illustrated embodiments depict a side mounted telecoil 12 in the telecoil assembly 10 and the cover packaged telecoil assembly 30. For small telecoil assemblies, a telecoil 122 may be end mounted, as illustrated by the telecoil assembly 120 illustrated in FIG. 11. Similar to the side mounted telecoil assembly 10 of FIGS. 1a and 1b, the end mounted telecoil assembly 120 comprises an amplifying integrated circuit 124 and a substrate 126. The difference between the side mounted telecoil assembly 10 and the end mounted telecoil assembly 120 is that the telecoil 122 is cemented to the integrated circuit 124 by its end instead of its side. The components and the electrical connections between the components of the end mounted telecoil assembly 120 are identical to the side mounted telecoil 10 described above.

FIGS. 12a and 12b illustrate one embodiment of a covered packaged telecoil assembly 130A comprising the end mounted telecoil 122. The assembly 130A comprises a cover 132A joined to the substrate 126 to form a unitary protective package. The cover 132A and the substrate 126 encase the telecoil 122 and the integrated circuit 124. The cover 132A in FIG. 12a may be considered an end mounted cover because the cover 132A has one open end to envelop over the telecoil 122. The same packaging concepts as applied above with respect to the side mounted assembly 30 apply for the end mounted assembly 130A, except that the shape of the cover 132A is elongated to enclose the end mounted telecoil 122. The cover 132A is properly dimensioned and shaped to accommodate the end mounted telecoil 122. Although the illustrated embodiment shows the cover 132A as generally rectangular, the cover 132A may be cylindrical or any other shape. The cover 132A depicted in FIG. 12 has edges comprising terminating walls of the cover 132A that abut the top surface of the substrate 126. In an alternative embodiment, the cover 132A may have edges that turn flat, similar to the edges 34 of FIG. 3a.

To form the unitary package, the cover 132A is bonded or joined to the substrate 126 using an appropriate adhesive or weld. To protect from environmental contamination, the bond between the cover 132A and the substrate 126 is sealed. The sealing fills any openings or gaps between the cover 132A and the substrate 126. The seal may be formed with an appropriate epoxy or polyurethane coating as described above. In an alternative embodiment, the cover 132A, after being bonded to the substrate, may be filled with an encapsulating material, such as epoxy, to prevent environmental contamination. The epoxy fills the space enclosed between the cover 132A and the substrate 126, as described above, in conjunction with the side mounted cover 32.

The cover 132A is composed of a material which allows the cover packaged telecoil assembly 130A to be handled without easily damaging. For example, the cover 132A should be able to withstand the forces applied by manual placement and/or the standard pick-and-place manufacturing techniques. FIGS. 12c and 12d illustrate the cross-section of one embodiment of the cover 132A. In one embodiment, the cover 132A comprises a non-ferrous drawn metal, such as a nonmagnetic metal, including stainless steel, brass, and copper, similar to the side mounted cover 32A of FIGS. 3a and 3b. In an alternative embodiment, the cover 132A may comprise a plastic material similar to the embodiment of FIGS. 4a and 4b.

Because the end mounted telecoil 122 is susceptible not only to physical damage but also to electromagnetic interference, it is desired that the packaging provide RF electromagnetic shielding for the enclosed end mounted telecoil 122. The RF shielding embodiments described above with respect to the side mounted telecoil assembly 30 also apply to the end mounted telecoil assembly 130A. For example, the RF shield may be provided by the cover 132A composed of the nonmagnetic metal and the substrate 126 having a metallic ground plane 128 as described for the side mounted assembly 30A of FIGS. 3a and 3b. Additionally, the cover 132A may comprise a plastic layer coated with an outer and an inner layer of metal, such as gold, as described above for the side mounted assembly 30B of FIGS. 4a and 4b.

FIGS. 13a and 13b illustrate another RF shielding embodiment for the end mounted assembly 130B similar to the embodiment for the side mounted assembly 30C of FIGS. 5a and 5b. The cover 132B comprises three metal portions 140, 142 and 144 physically and electrically connected together to form the unitary cover 132B. The three metal portions 140, 142 and 144 are connected by appropriate means, such as welded or soldered together. To provide the RF shielding, the first metal portion 140 and the third metal portion 144 are highly magnetic metals, such as highly permeable NiFe metal. The center metal portion 142 is a non-magnetic metal, such as stainless steel, brass, or copper. To complete the RF shield, the cover 132B is electrically connected to the edges and ends of the ground plane 128 on the substrate 126. The three portion metal cover depicted in FIG. 13a provides the continuous conductor path around the telecoil 120 in all three orthogonal planes. Additionally, the embodiment of FIG. 13a enhances the sensitivity of the telecoil 122. The high permeability NiFe metal portions 140 and 144 are placed around the ends of the telecoil bobbin. Joining and separating these portions 140 and 144 are the electrically conductive, but nonmagnetic, central portion 142. This arrangement increases the magnetic flux concentrating function of the telecoil bobbin by several decibels (dB). Thus, the effective sensitivity of the telecoil 122 to audio frequency magnetic fields is increased.

The end mounted cover packaged telecoil assembly 130, like the side mounted assembly 30, includes surface mount contacts. The various embodiments for the surface mount contacts described above with respect to the side mounted cover packaged telecoil assembly 30 may be readily applied to the end mounted cover packaged telecoil assembly 130. Two embodiments of surface mount contacts for the end mounted cover packaged telecoil assembly 130 will be illustrated and described in is detail below.

FIGS. 12a and 12b illustrate one embodiment of surface mount contacts 146, 148 and 150 for the end mounted cover packaged telecoil assembly 130A. The contacts 146, 148 and 150 are metal tabs welded to the bottom surface of the substrate 126. Electrically conductive connection pads and/or traces (not shown) provide the electrical connections between the terminals of the integrated circuit 124 through the substrate 126 to the contacts 146, 148 and 150. The contacts 146, 148 and 150 are folded under an adjacent side to provide contact areas on both the side and bottom of the assembly 130A. As illustrated in FIGS. 12a and 12c, the folded under surface mounted contacts 146, 148 and 150 do not contact the cover 132A. FIGS. 13a and 13b illustrate another embodiment of surface mounted contacts 152, 154 and 156 for the end mounted cover packaged telecoil assembly 130B. The illustrated embodiment is identical to that of FIGS. 12a and 12b except that the lead tabs are turned out away from the assembly 130B.

FIG. 14 illustrates another packaging embodiment for a side mounted telecoil assembly 10, as depicted in FIG. 1. A mold packaged telecoil assembly 160 comprises an ecapsulent package 162 joined to the substrate 16 to form a unitary protective package. The ecapsulent package 162 and substrate 16 encase the telecoil 12 and the integrated circuit 14. The ecapsulent package 162 is properly dimensioned and shaped to enclose the side mounted telecoil assembly 10 while minimizing the overall size of the protective package. In other embodiments, size may not be a consideration for the protective package.

The cross-sectional shape of the ecapsulent package 162 may be any shape that accommodates the telecoil 12, including rectangular, semicircular, elliptical, parabolic, and trapezoidal. For example, the cross-sectional shape of the ecapsulent package 162 in FIG. 14 is approximately rectangular. In one embodiment, the cross-sectional shape is selected to minimize the overall size of the mold packaged telecoil assembly 160. In another embodiment, the cross-sectional shape may be influenced by the automated pick-and-place manufacturing techniques.

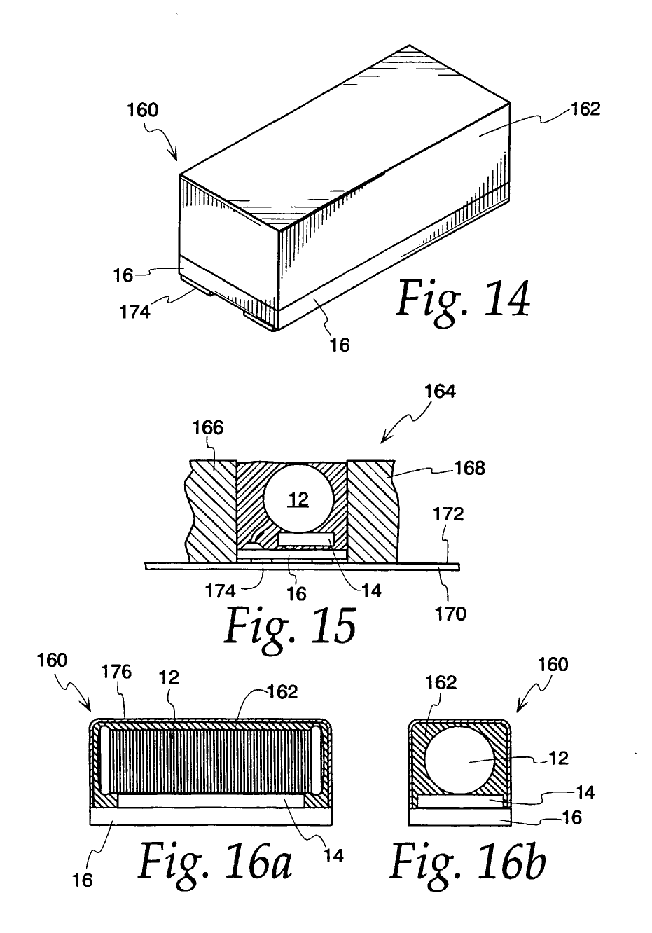

The ecapsulent package 162 is composed of a material to allow the mold packaged telecoil assembly 160 to be handled without easily damaging. For example, the ecapsulent package 162 should be able to withstand the forces applied by manual placement and/or the standard pick-and-place manufacturing techniques. To form the unitary package comprising the substrate 16 and the ecapsulent package 162, the ecapsulent package 162 is formed directly on the top surface 24 of the substrate 16 over the telecoil 12 and the integrated circuit 14. FIG. 15 illustrates one embodiment of a mold 164 for encasing the telecoil 12 and the integrated circuit 14 in the ecapsulent package 162. The mold 164 is properly shaped and dimensioned to accommodate and fully encase the telecoil assembly 10 with the ecapsulent. The mold 164 has vertical walls 166 and 168 composed of or coated with a substance, such as polystyrene, silicon rubber, or another appropriate substance, that allows the ecapsulent package 162 to be easily removed from the mold 164. The distance between the walls 166 and 168 is approximately equal to the width of the substrate 16 to prevent any liquid ecapsulent from leaking from the mold.

To form the ecapsulent package 162 over the telecoil 12 and the integrated circuit 14, the complete telecoil assembly 10 would be positioned within the mold 164. Before placing the telecoil assembly 10 within the mold 164, the telecoil 12 should be cemented to the integrated circuit 14 and the terminals 22 (FIGS. 1a and 1b) of the integrated circuit 14 connected to the top surface of the substrate 16 as described above in conjunction with FIGS. 1a and 1b. Additionally, surface mount contacts 174 may be formed on the substrate 16 and electrically connected to the terminals of the integrated circuit 14 as described above prior to placing the assembly 10 within the mold 164. To prevent the contacts 174 from being contaminated by the ecapsulent package, a tape 170 with an adhesive side 172 bonds to the surface mount contacts 174.

Once the telecoil assembly is positioned within the mold 164, a low viscosity, high temperature thermal set epoxy fills the mold 164. In one embodiment, the epoxy may be a quick-set epoxy or other suitable quick-set material for high volume production methods. The epoxy fills the empty spaces within the mold 164 to completely encase the telecoil 12 and the integrated circuit 14. The epoxy thermal sets harden to a solid, forming the ecapsulent package 162 sealed to the substrate 16.

FIGS. 16a and 16b illustrate a cross-section of the mold packaged telecoil assembly 160. The epoxy 162 completely fills the spaces between the telecoil 12, the integrated circuit 14, and the substrate 16, forming a unitary article with the substrate 16 as the base. Once the epoxy 162 has set, the mold packaged telecoil assembly 160 is removed from the mold 164. The set epoxy package 162 provides the rigid packaging walls that provide sufficient structural strength to protect the telecoil 12 from damage when the assembly 160 is handled.

Because the telecoil 12 is susceptible not only to physical damage but also to electromagnetic interference, it is desired that the packaging provide RF electromagnetic shielding for the enclosed telecoil 12. The mold packaged telecoil assembly 160 may provide such RF shielding by applying the shielding concepts discussed above in conjunction with the cover packaged telecoil assembly 30. As explained above, the shield must be electrically conductive and, at least in part, nonmagnetic to allow the telecoil 12 to perform its function of detecting audio band magnetic fields. To be effective, the shield should enclose the telecoil 12 with minimum non-conductive openings and provide conductive paths around the periphery of the shield in all three orthogonal planes.

In one embodiment, the mold packaged telecoil assembly 160 may include a metal layer 176 as illustrated in FIGS. 16a and 16b to provide RF shielding. The metal layer 176 of the mold package telecoil assembly 160 is similar to the metal coatings 44 on the plastic cover 32B of FIGS. 4a and 4b. The metal layer 176 is connected to the sides and ends of the ground plane on or within the substrate 16. In an another embodiment, the mold packaged telecoil assembly 160 may further include a plastic layer (not shown), such as parylene covering the metal layer 176, and a further metal layer (not shown) covering the plastic layer. The second metal layer provides an additional RF shield for the mold packaged telecoil assembly 160.

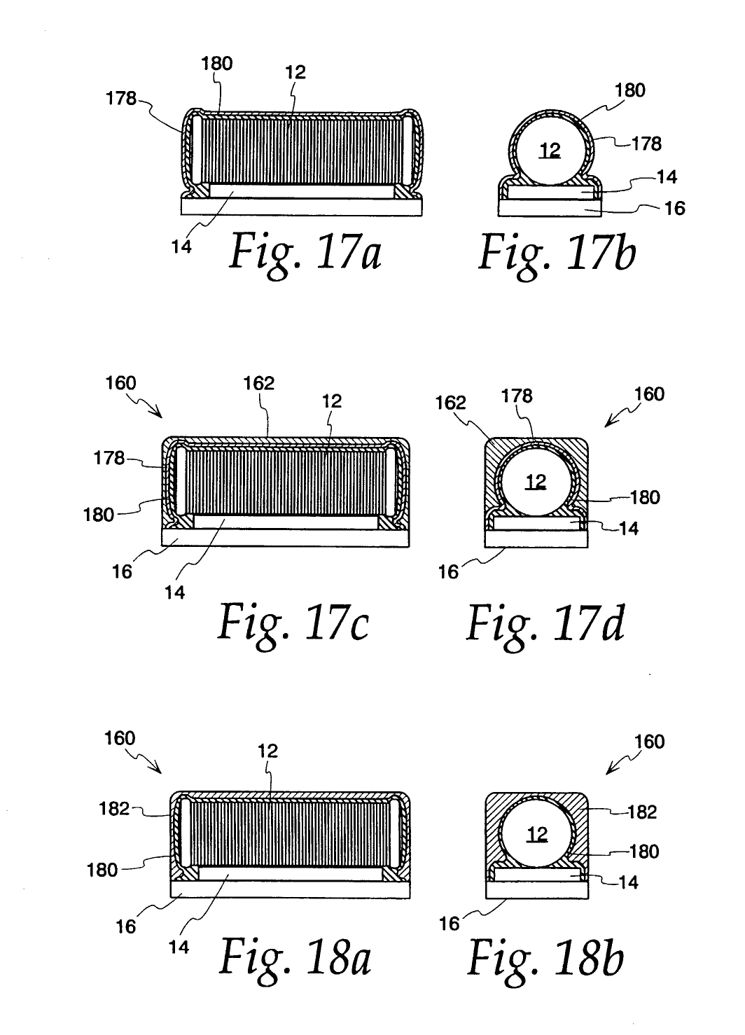

FIGS. 17c and 17d illustrate another embodiment of RF shielding for the mold packaged telecoil 160. Instead of having the metal layer 176 over the ecapsulent package 162, as shown in FIG. 16a, a metal layer 178 is beneath the ecapsulent package 162. Before the metal layer 178 may be applied, a conformal protective layer 180 is applied to encase the telecoil 12 and the integrated circuit 14 (see FIGS. 17a and 17b). The conformal protective layer 180 only abuts the top surface of the substrate 16. The conformal protective layer 180 protects the telecoil 12 and the integrated circuit 14 from contamination by the metal layer 178. The conformal protective layer may comprise an epoxy or a polyurethane, such as HUMISEAL 1A20 and CONATHANE EE-1164. To complete the RF shield, the metal layer 178 encases the telecoil 12 and connects to the sides and edges of the ground plane on or within the substrate 16. The telecoil assembly with the conformal protective layer 180 and the metal layer 178, as depicted in FIGS. 17a and 17b, may then be placed into the mold 164 and encapsulated with the epoxy 162 as described above to form the assembly 160 illustrated in FIGS. 17c and 17d.

FIGS. 18a and 18b illustrate another embodiment for the RF shielded mold packaged telecoil assembly 160. The telecoil 12 and the integrated circuit 14 are encased in the conformal protective layer 180 as described above in conjunction with FIGS. 17a and 17b. Instead of adding the metal layer 178, a conductive encapsulating layer 182 encases the conformal protective layer 180, the telecoil 12, and the integrated circuit 14. The conductive encapsulating layer 182 is formed using the mold 164 depicted in FIG. 15. To complete the RF shield, the conductive encapsulating layer 182 electrically connects to the sides and edges of the ground plane within the substrate 16. In one embodiment, the conductive encapsulating layer 182 comprises a metal-filled or carbon-filled substance to provide the continuous conductor required by the RF shield. In addition to providing the RF shielding, the conductive encapsulating layer 182 provides the structural strength similar to the embodiment of FIG. 14.

In a further embodiment, the mold packaged telecoil assembly 160 may also be temperature insulated. A layer of temperature insulating material, such as Kapton, may encase the entire assembly 160 without contaminating the surface mount contacts. Alternatively, the epoxy for forming the ecapsulent package 162 may have temperature insulating properties. The temperature insulating properties may lessen the chance of the telecoil 122 being damaged by the high temperatures of reflow soldering techniques.

The mold package telecoil assembly 160 may also be produced with a split mold, injection molding technique, rather than the mold 164 depicted in FIG. 15. For the split mold technique, an appropriate mold comprises two portions that clamp together around the telecoil assembly 10. To provide surface mount contacts, a lead frame of metal tabs are welded to the top surface of a ceramic substrate to provide the surface mount contacts similar to the embodiment of FIGS. 10a and 10b. The two portions of the mold clamp together snuggly around the lead frame. The mold having suitable vent holes is pressure-filled with the thermal set epoxy described above. The epoxy sets, providing the mold packaged telecoil assembly 160. The split mold process for forming the mold packaged telecoil assembly may be performed in multiples, with the lead frame and a split mold having several cavities to form several assemblies. The resulting assemblies come out of the mold in an array held together by the lead frame that may be cut apart to separate individual assemblies.

The above embodiments of the mold packaged telecoil assembly 160 have been described in conjunction with the side mounted telecoil assembly 10. The mold package telecoil assembly 160, however, may be readily applied to package the end mounted telecoil assembly 120 depicted in FIG. 11. To accommodate the end mounted telecoil, the mold 164 would be appropriately shaped and dimensioned.

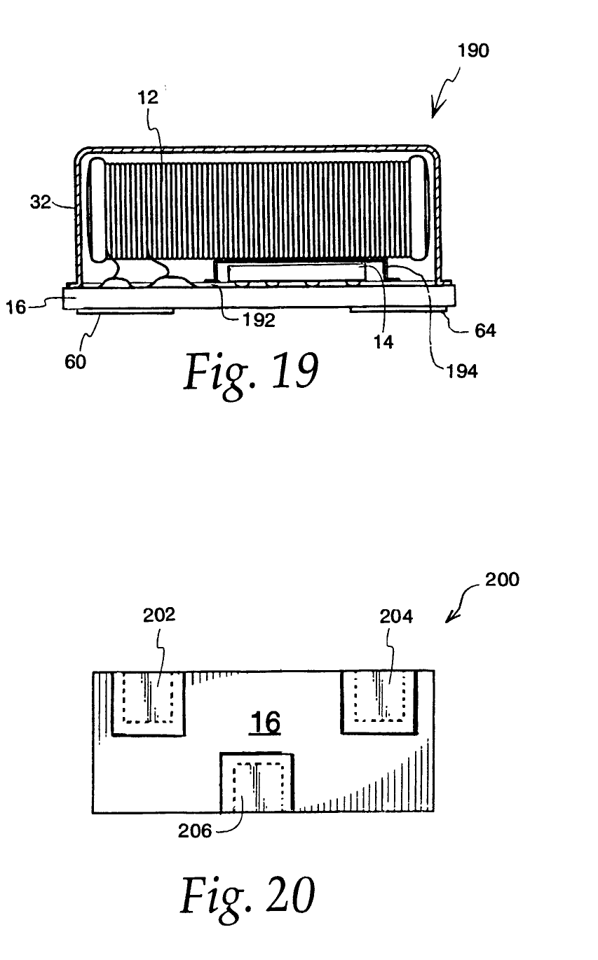

In a further embodiment described in FIG. 19, a telecoil assembly 190 includes a telecoil 12 that is internally shielded from the integrated circuit 14. Here, the substrate 16 includes a conductive ground plane 192 located at least partially on its upper surface. The contacts 60 and 64 are located on the bottom surface of the substrate 16. An internal shield 194 is connected to the conductive ground plane 192 in the same manner as the external cover 32 is connected to the ground plane 192. The internal shield 194 protects the telecoil 12 and its connecting wires from internal electromagnetic radiation that may be emanating from the components (e.g., digital circuits) on the integrated circuit 14. The internal shield 194 may encompass the entire integrated circuit 14, or only a portion of it that contains the components that may cause interference problems with the telecoil 12. Accordingly, the telecoil 12 is protected from external electromagnetic radiation via the cover 30 and internal electromagnetic radiation from the internal shield 194. The internal shield 194 may be used with any of the previous embodiments for the active telecoil systems.

FIG. 20 illustrates the bottom side of a telecoil assembly 200 that is very similar to FIG. 8A. In FIG. 20, the substrate 16 includes enlarged contacts 202, 204 and 206 that are substantially larger than the standard size contacts previously mentioned. For comparison, the standard size contacts are illustrated as dashed lines within each of the enlarged contacts 202, 204 and 206. Preferably, the area of the contacts 202, 204 and 206 are approximately 40% to 80% larger than the standard size contacts. This increased size provides hearing aid manufacturers with the ability to slightly adjust (i.e., to the left, right, up, down, and/or rotationally as viewed in FIG. 20) the location of the telecoil assembly 200 on the corresponding solder pads of the hybrid or printed circuit board on which the telecoil assembly 200 will be mounted. This positional adjustment may be needed to tune the hearing aid in that the adjustment of the telecoil assembly 200 may help suppress magnetic feedback loops in the hearing aid, such as those that exist between the receiver and the telecoil. In this situation, the solder is heated to the point where it becomes liquid, and the telecoil assembly 200 is moved to a more desirable position.

The packaged telecoil assemblies described above are particularly useful in the efficient and cost-effective assembly of hearing instruments. The packaged telecoil assemblies with their regular geometry, closely controlled dimensions, robustness, and surface mount contacts are ideal for surface mount applications. The packaged telecoil assemblies may be easily manually placed or placed with conventional automated pick-and-place equipment. Additionally, a large volume of the packaged assemblies may be arranged on standard tape-and-reel packaging for use on high volume, automated placement equipment. Furthermore, the packaged telecoil assemblies may be used in standard reflow solder techniques.

While the present invention has been described with reference to one or more particular embodiments, those skilled in the art will recognize that many changes may be made thereto without departing from the spirit and scope of the present invention. Each of these embodiments, and obvious variations thereof, are contemplated as falling within the spirit and scope of the claimed invention, which is set forth in the following claims.

What is claimed is:

1. A packaged telecoil assembly, comprising:
a telecoil induced by an external magnetic field to create an output signal corresponding to said external magnetic field, said telecoil joined to a substrate; and
a cover joined with said substrate to enclose said telecoil.

2. The packaged telecoil assembly of claim 1, further including an integrated circuit capable of receiving a signal from said telecoil, said integrated circuit connected to said substrate and enclosed by said cover.

3. The packaged telecoil assembly of claim 2, wherein said telecoil is mounted to said integrated circuit.

4. The packaged telecoil assembly of claim 3, wherein said telecoil has a side, said side of said telecoil is mounted to said integrated circuit.

5. The packaged telecoil assembly of claim 3, wherein said telecoil has an end, said end of said telecoil is mounted to said integrated circuit.

6. The packaged telecoil assembly of claim 1, wherein said cover has a rectangular shape.

7. The packaged telecoil assembly of claim 1, wherein said cover has a barn shape.

8. The packaged telecoil assembly of claim 1, wherein said cover has a cylindrical shape.

9. The packaged telecoil assembly of claim 1, wherein said cover is electrically conductive and at least partially nonmagnetic to provide RF shielding for said telecoil.

10. The packaged telecoil assembly of claim 9, wherein said substrate has an electrically conductive ground plane having edges and sides, said cover is electrically connected to at least one of said edge and said sides of said ground plane.

11. The packaged telecoil assembly of claim 9, wherein said cover is composed of metal.

12. The packaged telecoil assembly of claim 9, wherein said cover is composed of stainless steel.

13. The packaged telecoil assembly of claim 9, wherein said cover is composed of brass.

14. The packaged telecoil assembly of claim 9, wherein said cover is composed of copper.

15. The packaged telecoil assembly of claim 9, further including a non-electrically conductive coating over said cover.

16. The packaged telecoil assembly of claim 15, wherein said non-electrically conductive coating temperature insulates said telecoil.

17. The packaged telecoil assembly of claim 15, further including a second metal coating over said non-electrically conductive coating on said cover.

18. The packaged telecoil assembly of claim 9, wherein said cover comprises a nonmagnetic metal portion electrically connected between two highly magnetic portions.

19. The packaged telecoil assembly of claim 1, wherein said cover comprises a non-electrically conductive material.

20. The packaged telecoil assembly of claim 19, wherein the cover is composed of plastic.

21. The packaged telecoil assembly of claim 20, wherein said plastic cover has an electrically conductive and at least partially nonmagnetic metal coating to provide RF shielding for said telecoil.

22. The packaged telecoil assembly of claim 21, wherein said metal coating is composed of gold.

23. The packaged telecoil assembly of claim 21, wherein said substrate has an electrically conductive ground plane having edges and sides, said metal coating is electrically connected to at least one of said edge and said sides of said ground plane.

24. The packaged telecoil assembly of claim 21, wherein said plastic cover has an outer surface, said metal coating abutting said outer surface of said plastic cover.

25. The packaged telecoil assembly of claim 21, wherein said plastic cover has an inner surface, said metal coating abutting said inner surface of said plastic cover.

26. The packaged telecoil assembly of claim 1, further including an ecapsulent beneath said cover encasing said telecoil.

27. The packaged telecoil assembly of claim 1, wherein said cover comprises an ecapsulent encasing said telecoil.

28. The packaged telecoil assembly of claim 27, wherein said ecapsulent is an epoxy.

29. The packaged telecoil assembly of claim 27, further including an electrically conductive and at least partially nonmagnetic metal coating over said cover to provide RF shielding for said telecoil.

30. The packaged telecoil assembly of claim 29, wherein said metal coating is composed of gold.

31. The packaged telecoil assembly of claim 29, wherein said substrate has an electrically conductive ground plane having edges and sides, said metal coating is electrically connected to said edges and said sides of said ground plane.

32. The packaged telecoil assembly of claim 1, further including a conformal protective material encasing said telecoil.

33. The packaged telecoil assembly of claim 32, further including an electrically conductive and at least partially nonmagnetic metal coating over said conformal protective material to provide RF shielding for said telecoil.

34. The packaged telecoil assembly of claim 33, wherein said cover comprises an ecapsulent encasing said metal coating.

35. The packaged telecoil assembly of claim 32, wherein said cover comprises an ecapsulent encasing said conformal protective material, said ecapsulent composed of an electrically conductive and at least partially nonmagnetic material to provide RF shielding for said telecoil.

36. The packaged telecoil assembly of claim 35, wherein said substrate has an electrically conductive ground plane having edges and sides, said ecapsulent is electrically connected to said edges and said sides of said ground plane.

37. The packaged telecoil assembly of claim 1, further including an integrated circuit capable of receiving a signal from said telecoil and at least two surface mount contacts, said integrated circuit connected to said substrate and enclosed by said cover, said contacts being on an exterior surface of said substrate, said contacts providing electric connections to said integrated circuit.

38. The packaged telecoil assembly of claim 1, further including at least two surface mount contacts, said contacts are positioned on an exterior surface of said substrate, said contacts providing electric connections to said telecoil.

39. The packaged telecoil assembly of claim 38, wherein said exterior surface includes a bottom surface.

40. The packaged telecoil assembly of claim 38, wherein said exterior surface includes a bottom and side surface.

41. The packaged telecoil assembly of claim 38, wherein said exterior surface includes a side surface.

42. The packaged telecoil assembly of claim 38, wherein said contacts are formed using a screen printing process and a metal alloy paste on said substrate.

43. The packaged telecoil assembly of claim 38, wherein said contacts are formed by etching an electrically conductive layer on said substrate.

44. The packaged telecoil assembly of claim 38, wherein said substrate comprises flex print board, said contacts formed by etching an electrically conductive layer on said flex print board.

45. The packaged telecoil assembly of claim 38, wherein said flex print board wraps around a portion of said cover.

46. The packaged telecoil assembly of claim 38, wherein said contacts are formed by connecting at least two metal tabs to said substrate.

47. A packaged telecoil assembly, comprising:
a telecoil that is induced by an external magnetic field to create an output signal corresponding to said magnetic field, said telecoil including a winding of wire with two lead ends for transmitting said output signal;
means for amplifying said output signal into an amplified output signal, said amplifying means being coupled to said two leads ends;
electrical contacts for transmitting said amplified output signal to external components; and
a cover enclosing said telecoil and said amplifying means.

48. The packaged telecoil assembly of claim 47, further including a substrate having an electrically conductive paths between a pair of input terminals and a pair of output terminals, said input terminals being connected to said two lead ends of said telecoil, said output terminals being connected to said amplifying means, said electrical contacts being mounted on said substrate.

49. The packaged telecoil assembly of claim 48, wherein said cover has one open end that is dimensioned to fit tightly around said substrate.

50. The packaged telecoil assembly of claim 48, wherein said electrical contacts are integrally formed within said substrate.

51. The packaged telecoil assembly of claim 47, wherein said cover includes a polymeric material.

52. The packaged telecoil assembly of claim 51, wherein said polymeric material is covered with a layer of metal.

53. The packaged telecoil assembly of claim 51, wherein said layer of metal is a material that provides RF shielding.

54. The packaged telecoil assembly of claim 47, wherein said cover includes an encapsulated material formed over said amplifier means and said telecoil.

55. The packaged telecoil assembly of claim 54, further including a metallic layer in said encapsulated material providing RF shielding.

56. The packaged telecoil assembly of claim 47, wherein said contacts are enlarged in comparison with standard size contacts.

57. The packaged telecoil assembly of claim 56, wherein said enlarged contacts have a 40% to 80% larger area than standard size contacts.

58. The packaged telecoil assembly of claim 47, further including an internal shield around said amplifying means and a conductive ground plane, said internal shield and said cover being connected to said ground plane.

59. The packaged telecoil assembly of claim 47, further including a conductive ground plane coupled to said cover, said ground plane forming part of a bypass filter for reducing noise from said output signal of said telecoil.

60. A method for shielding a telecoil assembly, comprising:
providing a telecoil that creates an output signal corresponding to an input magnetic field to which said telecoil is exposed and an amplifier that amplifies the output signal into an amplified output signal; and
enclosing said telecoil and said amplifier with a covering structure that is electrically conductive and has at least one portion that is non-magnetic.

61. The method of claim 60, wherein said step of enclosing includes molding an encapsulating material around said telecoil and said amplifier, said encapsulating material being a part of said covering structure.

62. The method of claim 61, wherein said step of enclosing further includes attaching a metal layer to said encapsulated material.

63. The method of claim 62, wherein said step of attaching a metal layer includes coating said encapsulating layer with a metallic material.

64. The method of claim 60, wherein said step of providing further includes providing a substrate that is attached to said telecoil and said amplifier.

65. The method of claim 64, wherein said step of enclosing includes attaching said covering structure to said substrate.

66. The method of claim 60, wherein said enclosing includes adding a conformal protective layer over said telecoil.

67. The method of claim 60, wherein said covering structure includes an inner layer of metal and an outer encapsulating layer.

68. The method of claim 60, wherein said step of providing includes providing a substrate on which said amplifier and said telecoil are mounted, said substrate including surface mount contacts for monitoring said amplified output signal.

69. A packaged telecoil assembly, comprising:
a telecoil that is induced by an external magnetic field to create an output signal corresponding to said magnetic field; and
a structure having surface mount contacts for transmitting said output signal.

70. The packaged telecoil assembly of claim 69, wherein said structure is a substrate on which said telecoil is mounted.

71. The packaged telecoil assembly of claim 70, wherein said surface mount contacts are formed using a screen printing process on said substrate.

72. The packaged telecoil assembly of claim 70, wherein said surface mount contacts are formed by etching an electrically conductive layer on said substrate.

73. The packaged telecoil assembly of claim 69, wherein said structure comprises a flex print board, said surface mount contacts formed by etching an electrically conductive layer on said flex print board.

74. The packaged telecoil assembly of claim 73, wherein said flex print board wraps around a portion of a cover that partially encompasses said telecoil.

75. The packaged telecoil assembly of claim 70, wherein said telecoil is generally cylindrical around a central axis and said structure has an exterior surface generally parallel to said central axis, said surface mount contacts being on said exterior surface.

76. The packaged telecoil assembly of claim 70, wherein said telecoil is generally cylindrical around a central axis and said structure has an exterior surface that is transverse to said central axis, said surface mount contacts being on said exterior surface.

77. The packaged telecoil assembly of claim 70, wherein said contacts are enlarged in comparison with standard size contacts.

78. The packaged telecoil assembly of claim 77, wherein said enlarged contacts have a 40% to 80% larger area than standard size contacts.

79. The packaged telecoil assembly of claim 70, further including an integrated circuit for processing said output signal, said integrated circuit being connected between said telecoil and said surface mount contacts.

80. A method of mounting a telecoil assembly in a hearing aid, the telecoil assembly including a telecoil that is induced by an external magnetic field to create an output signal corresponding to said external magnetic field, comprising:
providing a telecoil assembly that is packaged with a structure having surface mount contacts for transmitting an output signal from said telecoil; and
soldering said surface mount contacts to an intermediate assembly within said hearing aid.

81. The method of claim 80, wherein said surface mount contacts are enlarged surface mount contacts, and further including the step of adjusting a position of said telecoil assembly on said intermediate assembly in said hearing aid.

82. The method of claim 81, wherein said adjusting step occurs simultaneously with said soldering step.

83. The method of claim 81, wherein said adjusting step occurs after said soldering step.

84. The method of claim 81, wherein said enlarged surface mount contacts are about 40% to about 80% larger than standard size surface mount contacts.
